(19) United States
(12) Patent Application Publication
(10) Pub. No.: US 2015/0072815 A1
(43) Pub. Date: Mar. 12, 2015

(54) SELF-ADJUSTING CHAIN TENSIONER

(71) Applicant: ANTHONY RICHARD ROBERTS, CORONA, CA (US)

(72) Inventor: ANTHONY RICHARD ROBERTS, CORONA, CA (US)

(21) Appl. No.: 14/022,227

(22) Filed: Sep. 10, 2013

(51) Int. Cl. F16H 7/08

(52) U.S. Cl. CPC F16H 7/08; F16H 2007/0891
USPC 474/111

(57) ABSTRACT

A self-adjusting chain tensioner is configured to adjust tension of a chain that connects a self-ratcheting tension drive pulley and a bearing pulley in response to ambient temperature. The self-adjusting chain tensioner has a dynamic block immediately adjacent to the chain with two pair of vertical plate guides. A horizontal plate is attached to the dynamic block with an inner spring and an outer spring. Vertical plates attached to the horizontal plate assists in movement of the dynamic block in a vertical direction. A bracket attached to the horizontal plate attaches the self-adjusting chain tensioner to a motorcycle. The inner spring and the outer spring can expand or contract in response to changes in the ambient temperature which adjusts a position of the dynamic block and thus keeps consistent tension on the chain which reduces wear on bearings in the bearing pulley.

### BACKGROUND

The embodiments herein relate generally to engine accessories. In particular, embodiments of the present invention relate to engine accessories for motorcycles.

A motorcycle has a self-ratcheting tension drive pulley and a bearing pulley that are connected with a chain. The bearing pulley turns around an axel covered with a bearing. The chain runs over a chain tensioner that that is rigid and does not allow chain movement. As the chain heats, from the heat of the engine for instance, it expands. As the chain cools, from the ambient air for instance, it contracts. However, the chain tensioner does not adjust, and as a result force of the bearing changes causing rapid bearing failure from this dynamic loading. Embodiments of the disclosed invention solve this problem.

### SUMMARY

A self-adjusting chain tensioner configured to adjust tension of a chain that connects a self-ratcheting tension drive pulley and a bearing pulley in response to ambient temperature, the self-adjusting chain tensioner comprising:

a dynamic block immediately adjacent to the chain; wherein the dynamic block further comprises a right side pair of vertical plate guides and a left side pair of vertical plate guides;

a horizontal plate mechanically coupled to the dynamic block with an inner spring and an outer spring permitting the dynamic block to move vertically;

a right side vertical plate mechanically coupled to the horizontal plate and immediately adjacent to the right side pair of vertical plate guides; wherein the right side vertical plate assists in movement of the dynamic block in a vertical direction;

a left side vertical plate mechanically coupled to the horizontal plate and immediately adjacent to the left side pair of vertical plate guides; wherein the left side vertical plate assists in movement of the dynamic block in the vertical direction;

a bracket mechanically coupled to the horizontal plate; wherein the bracket attaches the self-adjusting chain tensioner to a motorcycle;

wherein the inner spring and the outer spring can expand or contract in response to changes in the ambient temperature which adjusts a position of the dynamic block and thus keeps consistent tension on the chain which reduces wear on bearings in the bearing pulley

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of an embodiment of the invention shown in use.

FIG. 2 is a perspective view of an embodiment of the invention shown in use adapting to chain tension.

FIG. 3 is a perspective view of an embodiment of the invention.

FIG. 4 is a section detail view of an embodiment of the invention along line 4-4 in FIG. 1.

FIG. 5 is a section detail view of an embodiment of the invention along line 5-5 in FIG. 2.

FIG. 6 is a perspective view of an embodiment of the invention.

FIG. 7 is a perspective view of an embodiment of the invention.

FIG. 8 is a perspective view of an embodiment of the invention.

FIG. 9 is a perspective view of an embodiment of the invention.

### DETAILED DESCRIPTION OF CERTAIN EMBODIMENTS

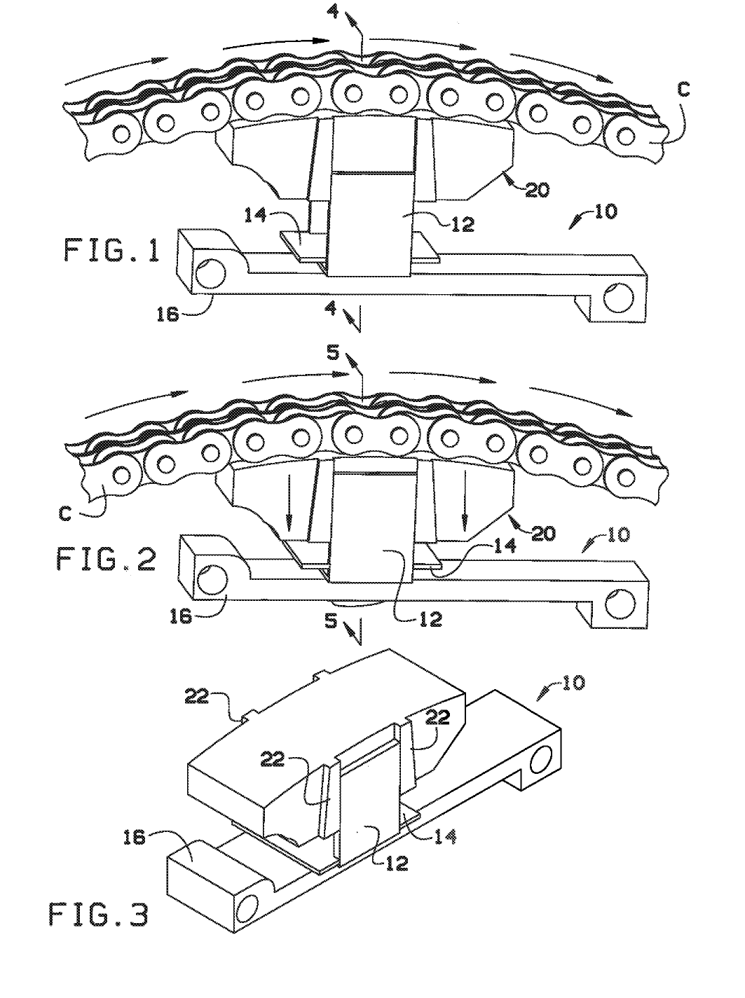

By way of example, and referring to FIG. 1, FIG. 2 and FIG. 3, one embodiment of self-adjusting chain tensioner 10 comprises two vertical plates 12 mechanically coupled to horizontal plate 14. Horizontal plate 14 is further mechanically coupled to bracket 16. Bracket 16 can be used to affix horizontal plate 14 to a motorcycle.

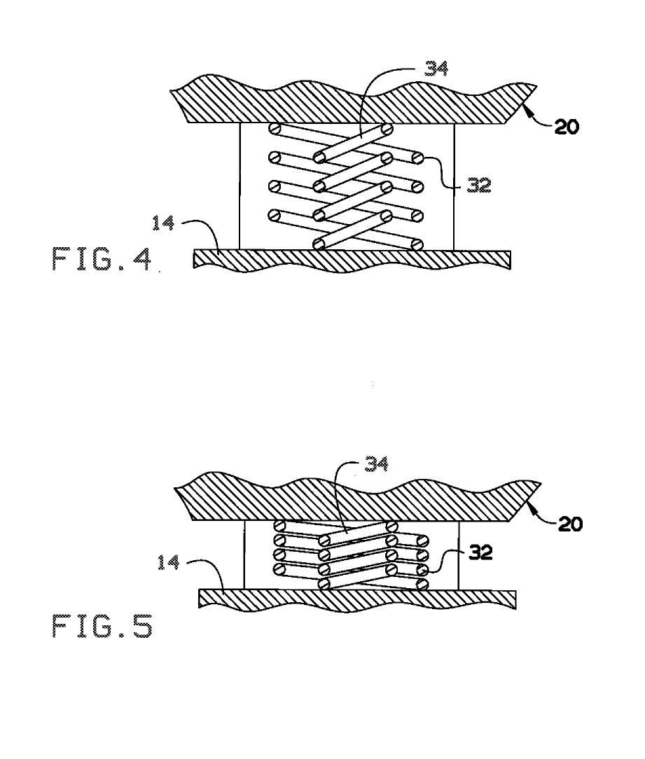

Turning to FIG. 4 and FIG. 5, dynamic block 20 is immediately adjacent to vertical plates 16 and is mechanically coupled to horizontal plate 14 with inner spring 32 and outer spring 34. Dynamic block 20 comprises a right side pair of vertical plate guides 22 which accommodate the right side vertical plate 12. Dynamic block 20 comprises a left side pair of vertical plate guides 22 which accommodate the left side vertical plate 12. As shown in FIG. 4 and FIG. 5, this permits dynamic block 20 to move in a vertical direction and adjusts the position of dynamic block 20.

Dynamic block 20 can possess many different geometric arrangements, but the following is offered as exemplary. Dynamic block 20 generally takes the shape of an octahedron, modified as follows. A top face is rounded slightly permitting chain C to rest upon the top face and to run over the top face smoothly. The top face is immediately adjacent to a forward face, a back face, a left face and a right face, each of these extend downward and nearly normal to the top face. The front face is immediately adjacent to the left face, the right face and a bottom front face that angles downward and toward the middle of the dynamic block. Likewise, the back face is immediately adjacent to the left face, the right face and a bottom back face that angles downward and toward the middle of the dynamic block.

The bottom back face and the bottom front face are both immediately adjacent to a bottom face. The bottom face possesses a cavity which can accommodate inner spring 32 and outer spring 34.

Inner spring 32 can be made in many manners, but the following is exemplary. Inner spring 32 can have a spring constant (k) of 55 lb/in, a 0.075 inch diameter with a right hand wrap. Inner spring 32 can be shock peened steel.

Outer spring 34 can be made in many manners, but the following is exemplary. Inner spring 34 can have a spring constant (k) of 125 lb/in, a 0.105 inch diameter with a left hand wrap. Inner spring 32 can be shock peened steel.

In this embodiment, inner spring 32 and outer spring 34 are wound in opposite directions. Outer spring 34 has a greater spring constant than inner spring 32. Both inner spring 32 and outer spring 34 are made of materials that change size in response to heat, which makes them particularly adaptable changes in ambient temperature around chain C.

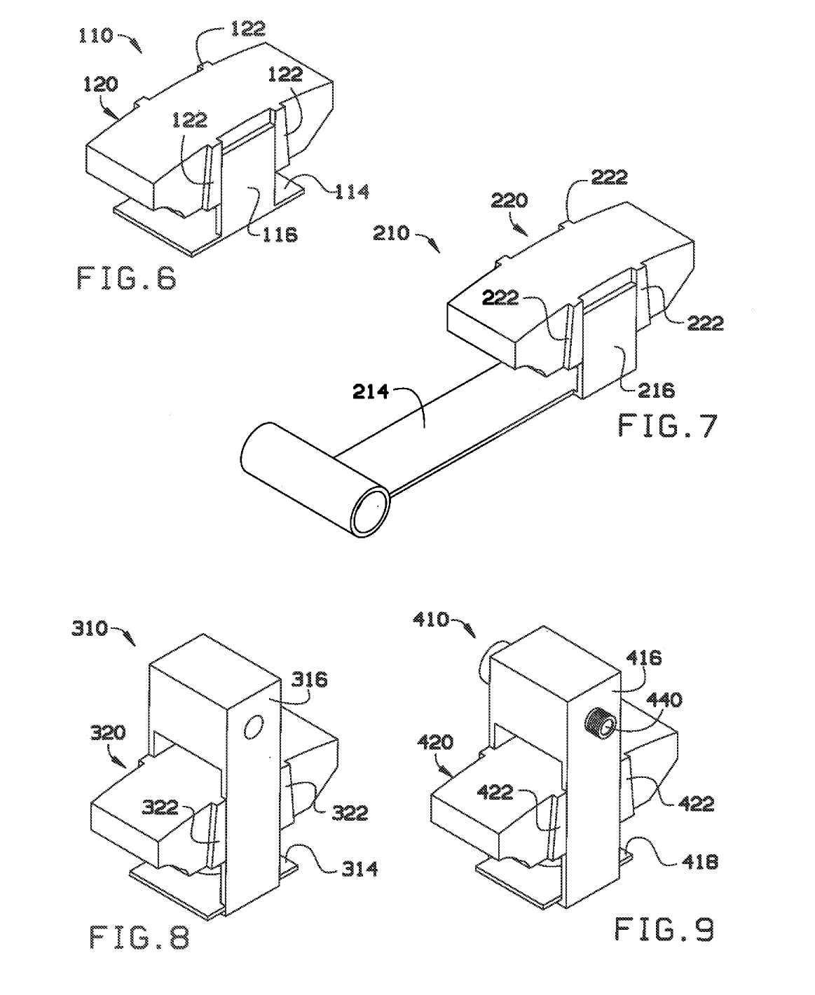

To install self-adjusting chain tensioner 10, a user simply selects the correct bracket for the preexisting chain tensioner and replaces it with the self-adjusting chain tensioner 10. There are many designs for bracket 16 as shown in FIG. 6 though FIG. 9.

FIG. 6 shows a situation where no bracket is needed. Self-adjusting chain tensioner 110 comprises dynamic block 120. Dynamic block 120 comprises a right side pair of vertical plate guides 122 which accommodate the right side vertical plate 116 on bracket 114. Dynamic block 120 comprises a left side pair of vertical plate guides 122 which accommodate the left side vertical plate 116 on bracket 114.

FIG. 7 shows a situation where a longer bracket is needed. Self-adjusting chain tensioner 210 comprises dynamic block 220. Dynamic block 220 comprises a right side pair of vertical plate guides 222 which accommodate the right side vertical plate 216 on bracket 214. Dynamic block 220 comprises a left side pair of vertical plate guides 222 which accommodate the left side vertical plate 216 on bracket 214.

FIG. 8 shows a situation where a taller bracket is needed. Self-adjusting chain tensioner 310 comprises dynamic block 320. Dynamic block 320 comprises a right side pair of vertical plate guides 322 which accommodate the right side vertical plate 316 on bracket 314. Dynamic block 320 comprises a left side pair of vertical plate guides 322 which accommodate the left side vertical plate 316 on bracket 314.

FIG. 9 shows a situation where a taller bracket with a bolt is needed. Self-adjusting chain tensioner 410 comprises dynamic block 420. Dynamic block 420 comprises a right side pair of vertical plate guides 422 which accommodate the right side vertical plate 416 on bracket 414. Dynamic block 420 comprises a left side pair of vertical plate guides 422 which accommodate the left side vertical plate 416 on bracket 414. Left side vertical plate 416 and right side vertical plate 416 are perforated to accommodate bolt 440.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A self-adjusting chain tensioner configured to adjust tension of a chain that connects a self-ratcheting tension drive pulley and a bearing pulley in response to ambient temperature, the self-adjusting chain tensioner comprising:
a dynamic block immediately adjacent to the chain; wherein the dynamic block further comprises a right side pair of vertical plate guides and a left side pair of vertical plate guides;
a horizontal plate mechanically coupled to the dynamic block with an inner spring and an outer spring permitting the dynamic block to move vertically;
a right side vertical plate mechanically coupled to the horizontal plate and immediately adjacent to the right side pair of vertical plate guides; wherein the right side vertical plate assists in movement of the dynamic block in a vertical direction;
a left side vertical plate mechanically coupled to the horizontal plate and immediately adjacent to the left side pair of vertical plate guides; wherein the left side vertical plate assists in movement of the dynamic block in the vertical direction;
a bracket mechanically coupled to the horizontal plate; wherein the bracket attaches the self-adjusting chain tensioner to a motorcycle;
wherein the inner spring and the outer spring can expand or contract in response to changes in the ambient temperature which adjusts a position of the dynamic block and thus keeps consistent tension on the chain which reduces wear on bearings in the bearing pulley.

2. The self-adjusting chain tensioner of claim 1, wherein the inner spring and the outer spring are wound in opposite directions.

3. The self-adjusting chain tensioner of claim 1, wherein the outer spring has a greater spring constant than the inner spring.

4. The self-adjusting chain tensioner of claim 1, wherein the inner spring and the outer spring are made of shock peened steel.

5. The self-adjusting chain tensioner of claim 1, wherein the dynamic block comprises a top face that is rounded slightly permitting the chain to rest upon the top face; the top face is immediately adjacent to a forward face, a back face, a left face and a right face, each of these extend downward and nearly normal to the top face; a front face is immediately adjacent to the left face, the right face and a bottom front face that angles downward and toward the middle of the dynamic block; the back face is immediately adjacent to the left face, the right face and a bottom back face that angles downward and toward the middle of the dynamic block; the bottom back face and the bottom front face are both immediately adjacent to a bottom face; the bottom face comprises a cavity comprises the inner spring and the outer spring.
